(19) United States
(12) Patent Application Publication
(10) Pub. No.: US 2012/0110314 A1
(43) Pub. Date: May 3, 2012

(54) BOOTING ACCESS METHOD AND MEMORY DEVICE OF EMBEDDED SYSTEM

(75) Inventors: Ming-Sung Chiang, Taipei (TW); Yong-Der Lee, Taipei (TW); Li-Pin Yeh, Taipei (TW); Fong-Chi Chan, Taipei (TW); Wen-Cheng Ko, Taipei (TW)

(73) Assignee: ASUSTEK COMPUTER INC., Taipei (TW)

(21) Appl. No.: 13/283,561

(22) Filed: Oct. 27, 2011

(30) Foreign Application Priority Data
Oct. 28, 2010 (CN) 201010522889.1

(51) Int. Cl. G06F 15/177

(52) U.S. Cl. 713/2

(57) ABSTRACT

A booting access method and a storage device of an embedded system are provided. The booting access method of the embedded system is applied to the storage device which includes a master boot record (MBR) section, a hidden section and a public section to improve access precision of embedded memory data. The access method includes: using the MBR section to access data of the public section when a normal booting signal is received; using a boot loader in the hidden section to update the MBR section and then accessing data of the public section when a trigger update signal is received.

### CROSS-REFERENCE TO RELATED APPLICATION

This application claims the priority benefit of China application serial no. 201010522889.1, filed on Oct. 28, 2010. The entirety of the above-mentioned patent application is hereby incorporated by reference herein and made a part of this specification.

### BACKGROUND OF THE INVENTION

1. Field of the Invention

The invention relates to a booting access method and a storage device of an embedded system and, more particularly, to an access method and a storage device for updating a master boot record (MBR) section.

2. Description of the Related Art

In a method of storing data or programs in an embedded memory, embedded secure digital (eSD) and embedded multimedia card (eMMC) use a master boot record (MBR) section to plan the storing content. The MBR section is stored in first 512 bytes of memory address of the storage device, 446 bytes of the 512 bytes are used to store programs, and 64 bytes are used to store a partition table. The partition table is used to store sizes and starting addresses of different memory segments. Thus, system program can use the partition table to access data of the memory.

Since the MBR section only can store relating addresses of four memory segments at most, and if the memory segments are more than four, the eSD or eMMC needs an extended boot record (EBR) section additionally to access other memory segments.

Both the MBR section and the EBR section are defined according to standard specification. Thus, users can use tool software to read the records and rewrite the content of the MBR section or the EBR, which may result in the embedded memory data damage under unpredicted state and a system operation error. Taking a boot loader, which is an important part in the system booting function of the embedded products, as an example, the boot loader is usually stored via the following methods.

One method is that the boot loader is stored in the MBR section. The MBR section only reserves 446 bytes to store the boot loader. 446 bytes are enough to store the boot loader for an embedded system with simple functions. However, for an embedded product with complicated functions such as the media play function, the initialization process is complicated when the system boots up, and it means that space needed by the boot loader is larger. If the boot loader is still stored in 446 bytes of the MBR section, it may be limited due to its larger size.

Another method is that the boot loader is stored in a general type memory segment instead of the MBR. Since a part of the memory segments are occupied, the available memory segments are reduced, and the memory segment storing the boot loader should be carefully maintained. Otherwise, if a program makes an accidental operation on the memory segment to damage the boot loader, the system function is greatly affected.

Moreover, no matter the boot loader is recorded in the MBR section or the mapping memory segment of the EBR, the user can use a tool program (such as Fdisk) to get the start address of the memory segment which stores the boot loader to access data. Consequently, the system cannot be protected with the method of using the memory segment. In addition, since the memory segment has no privacy, the data (especially the boot loader which is very important in booting the system) is easily damaged, and thus the system stableness is a potential problem in application of the embedded product.

### BRIEF SUMMARY OF THE INVENTION

In a booting access method of an embedded system, the embedded system includes a storage device, and the memory device includes a MBR, a hidden section and a public section. The booting access method includes: using the MBR section to access data of the public section when a normal booting signal is received; and using a boot loader in the hidden section to update the MBR section and then accessing data of the public section when a trigger update signal is received.

A storage device of the embedded system includes a MBR section, a hidden section and a public section. The MBR section is at first address of the storage device. The hidden section is at the second address of the storage device, and the second address is larger than the first address. The public section is at the third address of the storage device, and the third address is larger than the first address. When the embedded system receives a trigger update signal, a boot loader of the hidden section is used to update the MBR, and then the data of the public section are accessed.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing memory segments in an embodiment.

FIG. 2A is a flow chart showing an access process according to the memory segments when an embedded system is booted in an embodiment.

FIG. 2B is a flow chart showing that a boot loader of a hidden section updates a MBR section in an embodiment.

### DETAILED DESCRIPTION OF THE EMBODIMENTS

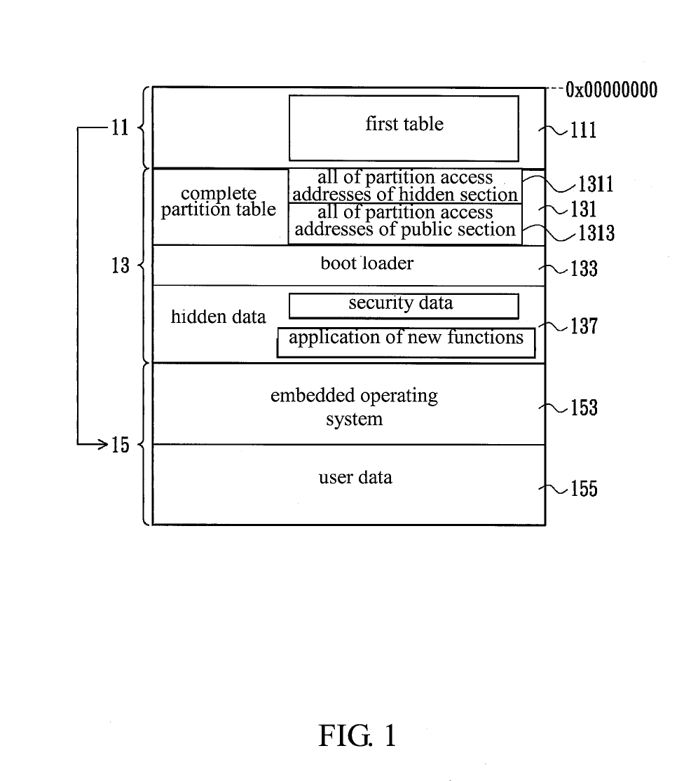

FIG. 1 is a schematic diagram showing memory segments in an embodiment. The memory segments of the embedded memory (storage device) are divided into three types, a MBR section 11, a hidden section 13 and a public section 15. The start address of the MBR section 11 is at first address of the storage device, and the start address of the MBR section 11 is at the position of 0x00000000 in FIG. 1. The start address of the hidden section 13 is at second address of the storage device, and the second address is larger than the first address. The start address of the public section 15 is at third address of the storage device, and the third address is larger than the first address. The order of the second address and the third address is not limited, that is, the hidden section 13 may be before the public section 15 as shown in FIG. 1, or the hidden section 13 may be after the public section 15.

The MBR section 11 can be used for storing a table and data. When the embedded system receives a normal booting signal, the embedded system starts the embedded operating system in the public section, and reads the data (such as user data 155) stored in the public section 15 via the record (such as a first table 111) provided by the MBR section 11. The data in the public section 15 includes data types such as the embedded operating system 153 and the user data 155.

The hidden section 13 provides a complete partition table 131, a boot loader 133 and hidden data 137 (including security data and application with new functions). That is, some programs with special functions are stored in the hidden section 13 for the embedded system to use in abnormal booting.

In the embodiment, the embedded memory provides different types of memory segments, and the use of the memory segment is based on the booting type of the embedded system, which means that different memory segments are used according to the received trigger signal.

For example, when the embedded system receives the normal booting signal, the boot loader 133 is used to boot the embedded operating system, the recorded data (such as the first table 111) of the MBR section 11 is used to access the user data 155 stored in the public section 15. If the embedded system receives a trigger update signal, the boot loader 133 in the hidden section 13 is used to determine and confirm the trigger update signal. Then, the boot loader 133 updates the MBR section 11, the embedded operating system boots up, and finally the updated MBR section 11 is used to access the data of the public section 15.

The trigger update signal may be generated by a hot key set at the embedded system or by controlling the embedded system via a computer system to activate a hot key when the embedded system is connected to the computer system. The hot key is used to activate the trigger update function and send the trigger update signal to the embedded system. Once the embedded system receives the trigger update signal, the embedded system boots up via the boot loader 133 in the hidden section 13, so as to avoid that the data of the MBR section 11 cannot be accessed when they are changed by other programs.

In the embodiment, the MBR section is provided for accessing data of the public section 15. Furthermore, the hidden section 13 is used to protect specific partition tables, data and programs, which are illustrated hereinafter.

The content of the complete partition table 131 provided by the hidden section 13 include two parts: all of partition access addresses 1311 of the hidden section and all of partition access addresses 1313 of the public section. The embedded system can access the data stored in the hidden section via the partition access addresses 1311 and access the data stored in the public section 15 via the partition access addresses 1313. In comparison, only all of the partition (the first table 111 in the embodiment) access addresses of the public section 15 are provided to the MBR section 11, and thus the data of the hidden section 13 cannot be accessed.

Except for the complete partition table 131, the hidden section 13 also provides the boot loader 133. Once the boot loader 133 is triggered and activated, some programs relating to trigger update are also executed.

The programs executed by the embedded system for the trigger update are as follows. The boot loader 133 first compares whether the data of the hidden section 13 and the data of the MBR section 11 are the same. If they are not the same, the boot loader 133 captures the data of the hidden section 13 to update the data of the MBR. The data of the hidden section 13 includes all partition access addresses of the public section of the complete partition table 131. The boot loader 133 may also execute the update directly, which means the boot loader 133 captures the data of the hidden section 13 to update the data of the MBR section without data comparing.

The function of the hidden section 13 is not limited to providing the complete partition table 131 and the boot loader 133, and it also may store some special application programs which are needed in using the embedded system, such as providing security data or providing applications with new functions.

In an embodiment, it is assumed that the system program of the embedded system A divides the storage device into the MBR section 11, the hidden section 13 and the public section 15 as shown in FIG. 1. If the system program of the embedded system A executes the normal booting, it accesses the data (such as the embedded operating system 153 and the user data 155) of the public section 15 via the MBR section 11. Only when the hot key operation of the embedded system A is enabled, for example, the user triggers the hot key of the embedded system A via tool program of the computer system connected to the embedded system A, or the hot key or combination keys of the embedded system A are pressed to trigger and activate the trigger update, the embedded system A can use the boot loader 133 provided by the hidden section 13 to update the MBR.

If the embedded memory is removed from the original embedded system A by the user and cooperates with other types of embedded product (such as an embedded system B), the embedded system B still can read the data stored in the public section 15 via the record in the MBR section 11 of the embedded memory.

For example, a company A develops an embedded system A and divides the memory segments as shown in FIG. 1. The user may use an embedded system B from another company. If he or she takes out the embedded memory from the embedded system A and installs it in the embedded system B, the embedded system B still can read the content of the MBR section 11 and access the data of the public section 15 via the first table 111 of the MBR section 11. However, the embedded system B cannot change the content of the hidden section 13.

Since the data of the MBR section 11 and the public section 15 of the embedded memory can be recognized by the embedded system B, the data stored in the public section can be read and even changed via the embedded system B. On the other hand, since the embedded system B does not provide the trigger update function, the embedded system B cannot get that the embedded memory also includes the hidden section 13 except the MBR section 11 and the public section 15. Thus, the system programs of the embedded system B cannot change the data stored in the hidden section 13.

If the user changes the content of the MBR section 11 via the tool program, the MBR section 11 cannot be used to access the data of the public section 15. In this situation, the embedded memory can use the hidden section 13 to recover the data in the MBR section 11. However, since the tool program cannot read the hidden section 13, it cannot change the content stored in the hidden section 13. Thus, the complete partition table 131, the boot loader 133, and the hidden data are all protected.

When the embedded memory is installed to the embedded system A again, the embedded system A restores the content of the MBR section 11 which is damaged by the tool program according to the content of the hidden section 13. Since the tool program cannot get the existence of the hidden section, it would not damage the data of the hidden section 13.

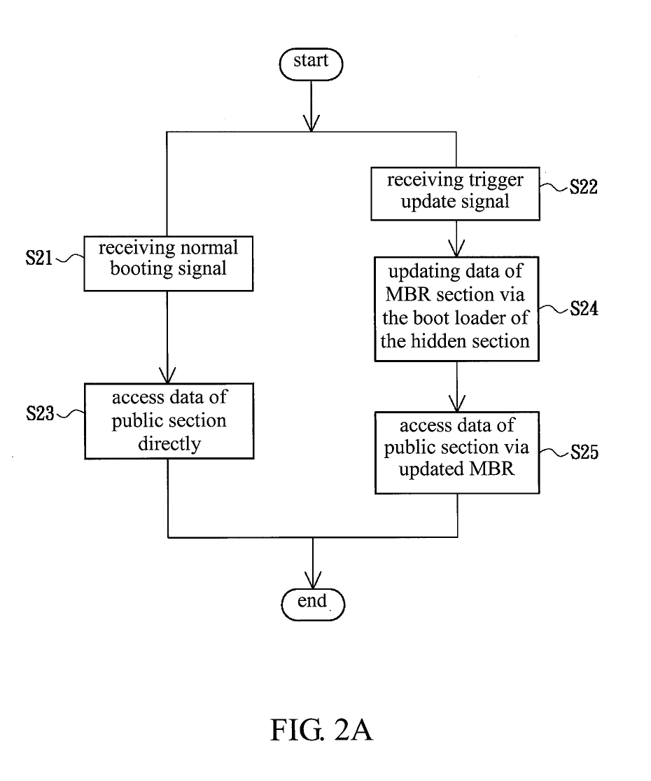

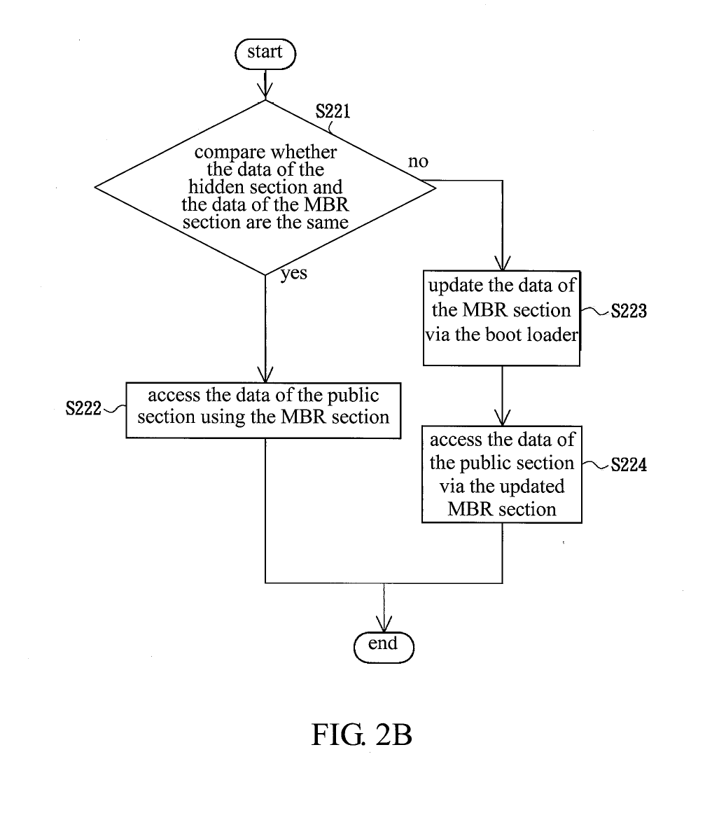

FIG. 2a is a flow chart showing an access process according to the memory segment when the embedded system is booted in an embodiment. After the embedded system receives a normal booting signal (Step S21), it accesses the data of the public section directly (Step S23). If the embedded system receives a trigger update signal (Step S22), the embedded system uses the boot loader of the hidden section to update the data in the MBR section first (Step S24), and then it access the data in the public section via the updated MBR section (Step S25).

The embedded memory originally installed in the embedded system A is taken as an example. The embedded system A maintains the first table 111 of the MBR section 11 and the complete partition table 131 of the hidden section 13 via the system program. The complete partition table 131 not only provides all of the partition access addresses of the public section 15, but also provides all of the partition access addresses of the hidden section 13. All of the partition access addresses of the public section 15 in the complete partition table 131 can ensure that the embedded system still can access the data of the public section 15 when the content of the MBR section 11 is damaged.

When the embedded memory changes to cooperate with the embedded system B, the system programs of the embedded system B can use the MBR section 11 to read the data of the public section 15. The user can also use tool software to read and even damage the content of the MBR section 11.

Since the complete partition table 131 includes the content the same as that in the first table 111 of the MBR section 11, even when the user damages the content of the MBR section 11 by using the embedded system of another type or the tool program, he or she only needs to install the embedded memory back to the embedded system A and activate the trigger update function via the hot key, and the content of the MBR section 11 can be restored via the complete partition table 131 and the boot loader 133 in the hidden section 13.

FIG. 2b is a flow chart showing that the boot loader of the hidden section updates the MBR section in an embodiment.

First, the data of the hidden section and the data of the MBR section are compared (Step S221). If they are the same, the embedded system directly uses the MBR section to access the data of the public section (Step S222). If the data of the hidden section and the data of the MBR section are different, the embedded system uses the boot loader to update the data of the MBR section (Step S223) and accesses the data of the public section via the updated data of the MBR section (Step S224).

In sum, the booting access method avoids that data or programs in the MBR section and the public section are easily damaged when the embedded memory is used, and the use of the embedded memory in the embodiment also can be compatible with the conventional technology. Furthermore, when the embedded product uses the embedded memory, it can make the memory segment more effective via a more flexible and safer data access method.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A booting access method of an embedded system, wherein the embedded system includes a storage device, and the storage device includes a master boot record (MBR) section, a hidden section and a public section, the access method comprising:
using the MBR section to access data of the public section when a normal booting signal is received; and
using a boot loader in the hidden section to update the MBR section and then accessing data of the public section when a trigger update signal is received.

2. The booting access method according to claim 1, wherein the hidden section includes a complete partition table recording all of partition access addresses of the hidden section and all of partition access addresses of the public section.

3. The booting access method according to claim 2, wherein when the boot loader of the hidden section updates the MBR, all of the partition access addresses of the public section recorded in the complete partition table are copied to the MBR.

4. The booting access method according to claim 1, wherein the step of using the boot loader in the hidden section to update the MBR comprises:
comparing whether the data of the hidden section and the data of the MBR section are the same, and
updating the MBR section via the boot loader if the data of the hidden section and the data of the MBR section are different.

5. The booting access method according to claim 1, wherein the trigger update signal is activated via a hot key in the embedded system.

6. The booting access method according to claim 5, wherein the activation of the hot key is controlled via a computer system connected to the embedded system.

7. The booting access method according to claim 1, wherein in the step of using the boot loader in the hidden section to update the MBR section and then accessing data of the public section, the updated MBR section is used to access the data of the public section.

8. A storage device of an embedded system, comprising:
a MBR section at a first address of the storage device;
a hidden section at a second address of the storage device, wherein the second address is larger than the first address; and
a public section at a third address of the storage device, wherein the third address is larger than the first address,
wherein when the embedded system receives a trigger update signal, a boot loader of the hidden section is used to update the MBR, and then the data of the public section are accessed.

9. The storage device according to claim 8, wherein the hidden section includes a complete partition table recording all of partition access addresses of the hidden section and all of partition access addresses of the public section.

10. The storage device according to claim 9, wherein when the boot loader of the hidden section updates the MBR, all of the partition access addresses of the public section recorded in the complete partition table are copied to the MBR.

11. The storage device according to claim 8, wherein the step of using the boot loader in the hidden section to update the MBR comprises:
comparing whether the data of the hidden section and the data of the MBR section are the same, and
updating the MBR section via the boot loader if the data of the hidden section and the data of the MBR section are different.

12. The storage device according to claim 8, wherein the trigger update signal is activated via a hot key in the embedded system.

13. The storage device according to claim 12, wherein the activation of the hot key is controlled via a computer system connected to the embedded system.

14. The storage device according to claim 8, wherein in the step of using a boot loader in the hidden section to update the MBR section and then accessing data of the public section, the updated MBR section is used to access the data of the public section.
